(19) United States
(12) Patent Application Publication
(10) Pub. No.: US 2005/0286401 A1
(43) Pub. Date: Dec. 29, 2005

(54) ROM-type optical recording medium and stamper for manufacturing ROM-type optical recording medium

(75) Inventors: Hisaji Oyake, Tokyo (JP); Yuuichi Kawaguchi, Tokyo (JP); Jin Kutsukake, Tokyo (JP); Kenichi Kitamura, Tokyo (JP); Takashi Koshimizu, Tokyo (JP); Koji Mishima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 11/167,315

(22) Filed: Jun. 28, 2005

(30) Foreign Application Priority Data
Jun. 29, 2004 (JP) 2004-190889
Aug. 30, 2004 (JP) 2004-250051
Aug. 30, 2004 (JP) 2004-250052

(51) Int. Cl. G11B 7/24

(52) U.S. Cl. 369/275.4; 369/275.1

(57) ABSTRACT

In a ROM-type optical recording medium including a substrate 2 having a plurality of concave pits 2a formed on a surface thereof, a light transmission layer 4, and a reflective layer 3 formed between the substrate 2 and the light transmission layer 4, and adapted to reproduce data by causing a laser beam to be irradiated through the light transmission layer 4, the concave pits 2a on the surface of the substrate 2 has a larger length than a basic length BL to be determined according to data to be recorded, and the length of spaces 2b between the concave pits 2a adjacent to each other in a track direction has a smaller length than the basic length BL.

### BACKGROUND OF THE INVENTION

The present invention relates to a ROM-type optical recording medium, and in particular, to a ROM-type optical recording medium which can obtain reproducing signals having good jitter characteristics, and can reproduce data as desired. More particularly, the ROM-type optical recording medium according to the invention has a reflective layer which places minimal burden on the global environment, or has excellent characteristics in the wear resistance and the flaw resistance at the light incident side.

The present invention also relates to a stamper for manufacturing a ROM-type optical recording medium, and in particular, to a stamper which makes it possible to manufacture a ROM-type optical recording medium which can obtain reproducing signals having good jitter characteristics, and can reproduce data as desired.

As conventional recording media for recording digital data, optical recording media such as CD (Compact Disc) and DVD (Digital Versatile Disc) have been widely used. These optical recording media can be roughly classified into ROM-type optical recording media such as CD-ROM (Read Only Memory) and DVD-ROM where data is not added or rewritable, write-once type optical recording media such as CD-R (Recordable) and DVD-R where data can be added but not rewritable, and rewritable optical recording media such as CD-RW (Rewritable) and DVD-RW where data is rewritable.

In the ROM-type optical recording media of the above-mentioned optical recording media, concave pits or convex pits are formed on the surface of a substrate, and data is recorded by these pits and spaces between the adjacent pits. ‘0’ or ‘1’ of digital data is caused to correspond to the pits and the spaces, and bit numbers of ‘0’ or ‘1’ is caused to correspond to the length of the pits and spaces. Accordingly, desired data can be recorded by modulating the length of pits and spaces.

Meanwhile, when the recorded data is reproduced, a laser beam is irradiated along tracks constructed on the substrate, and then a photodetector detects the amount of light reflected to thereby read a difference in the surface shape of the substrate. As a result, it is possible to reproduce data.

In manufacturing such ROM-type optical recording media, first, a photoresist is uniformly coated on a glass substrate, which has been polished and cleaned with precision, by a spin coating method, whereby a coated film of the photoresist is formed on the glass substrate. Next, a laser beam for exposure is irradiated onto the coated film of the photoresist to expose the coated film of the photoresist, whereby a latent image corresponding to pits of an optical recording medium is formed in concavo-convex patterns. Further, the glass substrate is immersed in chemicals, and the coated film of the exposed photoresist is developed, whereby either exposed regions or non-exposed regions are removed, concavo-convex patterns corresponding to the pits are formed on the glass substrate, thereby manufacturing a photoresist master.

Next, the surface of the photoresist master formed with the concavo-convex pattern is subjected to electroless plating to form a thin film such as an Ni film, and then a metal film is formed by electrolytic plating. Further, the thin film such as an Ni film and the metal film are peeled off together, whereby a stamper having a concavo-convex pattern transferred thereto is fabricated. Finally, the stamper is set in a mold and then a disk-shaped substrate having concave portions and convex portions formed on the surface thereon is fabricated.

Meanwhile, next-generation ROM-type optical recording media with larger capacity and higher data transfer rate have recently been suggested. In such next-generation optical recording media, the recording density is improved by increasing the numerical aperture NA of an objective lens that focuses laser beams, and by decreasing a wavelength λ of the laser beams.

However, when the numerical aperture NA of the objective lens for focusing laser beams is increased, as shown in the following Expression (1), a problem occurs in that the tolerable angular error of the tilting of the optical axis of the laser beam with respect to the optical recording medium, i.e., the tilt margin T becomes extremely narrow.

$$T ∝ \frac{λ}{d \cdot {NA}^{3}} \qquad ( 1 )$$

In Expression (1), d is the thickness of a layer through which a laser beam is transmitted until the laser beam reaches pits formed on the surface of the substrate. As clear from Expression (1), the higher the NA of the objective lens, the smaller the tilt margin T, and the smaller the thickness d of a layer through which a laser beam is transmitted, the larger the tilt margin T.

Thus, in the next-generation optical recording media, the tilt margin is widened by a construction in which a thin light transmission layer having a thickens of about 100 μm on a substrate is formed by a spin coating method, and a laser beam is irradiated from the light transmission layer to reproduce data. In other words, in the next-generation ROM-type optical recording medium, films are sequentially formed from the opposite side to the light incident side unlike the current optical recording media in which films are sequentially formed from the light incident side.

Meanwhile, in the ROM-type optical recording media, in order to obtain reproducing signals having high C/N ratio, it is general to form a reflective layer on a substrate and improve reflectance for laser beams. As the material forming such a reflective layer, various materials have been proposed hitherto. In order to effectively improve reproducing characteristics, it is required to select a material having a high optical reflectance and an excellent surface property. In particular, such requirements are strict for optical recording media having a high recording density and a high transfer rate. As a material for a reflective layer that can satisfy such requirements, silver (Ag) or alloys that contains silver as a main component is preferably used.

In the ROM-type optical recording media, in order to obtain reproducing signals having high C/N ratio, it is general to form a reflective layer on a substrate and improve reflectance for laser beams.

However, since the next-generation ROM-type optical recording media are adapted to irradiate a laser beam from the light transmission layer unlike the conventional CD-ROMs or DVD-ROMs, when a reflective layer is provided on the substrate, a laser beam incident on the optical recording media is reflected by the reflective layer before it reaches the surface of the substrate. For this reason, reproducing signals generated by a photodetector mainly does not correspond to surface shapes of the substrate but correspond to surface shapes of the reflective layer. As a result, when concave pits and spaces, or convex pits and spaces are formed on the substrate correspondingly to data to be recorded, there are problems in that jitter characteristics of reproducing signals deteriorate and thus it is extremely difficult to reproduce the recorded data as desired.

Further, with an increasing concern for global environment, the reflective layer of the optical recording medium should be made of materials of a smaller environmental burden.

Moreover, the increase in the reproduction error resulting from the flaw at the light incident side of a light transmission layer will be expected like a conventional optical recording medium with the spread of next generation ROM type optical recording media.

### SUMMARY OF THE INVENTION

It is therefore an object of the invention to provide a ROM-type optical recording medium which can obtain reproducing signals having good jitter characteristics, and can reproduce data as desired. Further, it is provided a ROM-type optical recording medium which has a reflective layer which places minimal burden on the global environment, and has excellent characteristics in the wear resistance and the flaw resistance at the light incident side.

It is also an object of the invention to provide a stamper which makes it possible to obtain a ROM-type optical recording medium which can obtain reproducing signals having good jitter characteristics, and can reproduce data as desired.

The inventors vigorously pursued a study for accomplishing the above object and, as a result, made the discovery that, even in a case where the concave pits and the spaces are formed on the substrate correspondingly to data to be recorded, when the data recorded on next-generation ROM-type optical recording media is reproduced, jitter characteristics of reproducing signals may deteriorate. According to the studies of the inventors, it was found that this is because the length of the concave portions of the reflective layer is smaller than that of the concave pits formed on the surface of the substrate, and the length of a gap between the adjacent concave portions is larger than that of the spaces formed on the surface of the substrate, as a result of that the length of the concave portions of the reflective layer and the length of the gap between the adjacent concave portions are detected by a photodetector, and thus the length of a concavo-convex pattern recognized by a data reproducing device does not coincides with the length corresponding to the recorded data.

Further, the inventors found that the deterioration of jitter characteristics of recording signals which appears when convex pits and spaces are formed on the substrate is also caused by the fact that the length of the convex pits and the spaces to be detected by a photodetector does not coincide with the length corresponding to the recorded data.

Further, the inventors found that it is possible to relieve an environment burden while ensuring good reproducing characteristics by selecting a material that contains aluminum (Al) as a main component and has an additive added thereto. The invention has been accomplished based on such findings.

Further, the inventors found that a hard coat layer formed on a surface of a light transmission layer is effective to improve the wear resistance and the flaw resistance of the light transmission layer at the light incident side without influencing of jitter characteristics of reproducing signals. The invention has been accomplished based on such findings.

Therefore, the invention has been made based on such knowledge, and the above object of the invention are accomplished by a ROM-type optical recording medium including: a substrate having a plurality of concave pits formed on a surface thereof; a light transmission layer; and a reflective layer formed between the substrate and the light transmission layer, and adapted to reproduce data by causing a laser beam to be irradiated through the light transmission layer. In such a ROM-type optical recording medium, the concave pits have a larger length than a basic length BL to be determined according to data to be recorded, and the length of spaces between the concave pits adjacent to each other in a track direction has a smaller length than the basic length BL.

In the invention, the basic length BL is a length which is determined according to the bit number of ‘0’ or ‘1’ of data to be recorded. For example, when data of 2 T or 8 T which has been modulated by 1-7RLL modulation is recorded on the next-generation ROM-type optical recording media in a recording capacity of 25 GB, the data has seven types of length of 149 nm, 223.5 nm, 298 nm, 372.5 nm, 447 nm, 521.5 nm, and 596 nm correspondingly to 2 T or 8 T.

According to the aspect of the invention, since the length of the concave portions formed on the reflective layer and the length of the gap between the concave portions can be made approximately equal to the basic length BL that is the length corresponding to data to be recorded, when the data recorded on the optical recording medium is reproduced, the length of concavo-convex patterns to be detected by a photodetector is approximately equal to the length corresponding to the recorded data. Accordingly, reproducing signals having good jitter characteristics can be obtained, and thus data can be reproduced as desired.

In the invention, it is preferable that if a distance from a surface of the reflective layer to the surface of the substrate is assumed as D, the concave pits have a length of BL+(0.1 to 0.3)·D, and the spaces between the concave pits have a length of BL−(0.1 to 0.3)·D, and it is more preferable that the concave pits have a length of BL+(0.15 to 0.25)·D, and the spaces between the concave pits have a length of BL−(0.15 to 0.25)·D.

If the concave pits have a length of BL+(0.1 to 0.3)·D, and the spaces between the concave pits have a length of BL−(0.1 to 0.3)·D, it is possible to make the concave pits formed on the reflective layer and the length of a gap between the concave portions approximately equal to the basic length BL.

In a more preferred embodiment of the invention, the reflective layer is formed of Ag or an alloy containing Ag. If the reflective layer is formed of Ag or an alloy containing Ag, it is possible to form a reflective layer having an excellent surface property. Accordingly, it is possible to reduce noises included in reproducing signals. Additionally, the reflective layer is made of a material that contains aluminum (Al) as a main component and has an additive added thereto. The main component indicates an element having the largest content (atomic %) in a layer concerned.

Further, the reflective layer is made of a material that contains aluminum (Al) as a main component and has an additive added thereto. Thus, it is possible to obtain desired high reproducing characteristics (the degree of modulation, reflectance and the like) while suppressing an environmental burden. In other words, since a material in which an additive is added to aluminum (Al) has a high reflectance, the reflectance for a laser beam can be sufficiently increased, and the surface property of reflective layer can be improved by virtue of the additive. Therefore, even in the next-generation ROM-type optical recording media in which a laser beam is irradiated from a film formation completion face, high reflectance can be ensured.

Further, according to the ROM-type optical recording medium of the present invention, because the hard coat layer is formed on the surface of the light transmission layer, the wear resistance and the flaw resistance at the light incident side is improved and thus the optical recording medium can be used without being accommodated in a cartridge.

According to the invention, it is possible to provide a ROM-type optical recording medium which can obtain reproducing signals having good jitter characteristics, and can reproduce data as desired.

According to the invention, it is also possible to provide a stamper which makes it possible to obtain a ROM-type optical recording medium which can obtain reproducing signals having good jitter characteristics, and can reproduce data as desired.

Further, it is provided a ROM-type optical recording medium which has a reflective layer which places minimal burden on the global environment, and has excellent characteristics in the wear resistance and the flaw resistance at the light incident side.

### BRIEF DESCRIPTION OF THE DRAWINGS

FIG. 1 is a schematic perspective view of an optical recording medium according to a first embodiment of the invention

FIG. 2 is a schematic enlarged sectional view of a portion indicated by A in FIG. 1.

FIG. 3 is a schematic perspective view of a substrate.

FIG. 4 is a sectional view taken along an axis X-X in FIG. 3, and a schematic enlarged sectional view showing the sectional shape of the surface of the substrate and the surface of a reflective layer.

FIG. 5 is a flow chart showing a manufacturing process of a photoresist master.

FIG. 6 is a flow chart showing a manufacturing process of a stamper.

FIG. 7 is a flow chart showing manufacturing process of an optical recording medium.

FIG. 8 is a schematic enlarged sectional view of an optical recording medium related to another preferred embodiment of the invention.

FIG. 9 is a schematic perspective view of the surface of a substrate.

FIG. 10 is a sectional view taken along an axis Y-Y in FIG. 9, and an enlarged sectional view showing the sectional shape of the surface of the substrate and the surface of a reflective layer.

FIG. 11 is a flow chart showing a manufacturing process of a mother stamper.

FIG. 12 is a partially cutaway perspective view showing the outline of a ROM-type optical recording medium according to a second embodiment of the invention.

FIG. 13 is a schematic enlarged sectional view of a portion indicated by A in FIG. 12.

FIG. 14 is a schematic perspective view of the surface of a substrate.

FIG. 15 is a sectional view taken in the thickness direction of the substrate along an axis X-X in FIG. 14, and a schematic enlarged sectional view showing the sectional shape of the surface of the substrate and the surface of a reflective layer.

FIG. 16 is a flow chart showing manufacturing process of an optical recording medium.

FIG. 17 is a schematic enlarged sectional view of a ROM-type optical recording medium related to another preferred embodiment of the invention.

FIG. 18 is a schematic perspective view of the surface of a substrate.

FIG. 19 is a sectional view taken in the thickness direction of the substrate along an axis Y-Y in FIG. 18, and an enlarged sectional view showing the sectional shape of the surface of the substrate and the surface of a reflective layer.

### REFERENCE NUMERALS

1: OPTICAL RECORDING MEDIUM
2: SUBSTRATE
2a: CONCAVE PIT
2b: SPACE
3: REFLECTIVE LAYER
3a: CONCAVE PORTION
3b: GAP BETWEEN CONCAVE PORTIONS
4: LIGHT TRANSMISSION LAYER
5: CENTER HOLE
20: GLASS SUBSTRATE
21: PHOTORESIST LAYER
21a: EXPOSED REGION
21b: NON-EXPOSED REGION
22: LASER BEAM FOR EXPOSURE
23a: CONCAVE PIT
23b: SPACE
30: PHOTORESIST MASTER
42: ELECTROLESS NICKEL LAYER
43: ELECTROLYTIC NICKEL LAYER
51: STAMPER
51a: CONVEX PIT
51b: SPACE
60: MOLD
70: OPTICAL RECORDING MEDIUM
72: SUBSTRATE
72a: CONVEX PIT
72b: SPACE
73: REFLECTIVE LAYER
73a: CONVEX PORTION
73b: GAP BETWEEN CONVEX PORTIONS
74: LIGHT TRANSMISSION LAYER
80: MASTER STAMPER
90: MOTHER STAMPER
90a: CONCAVE PIT
90b: SPACE
91: ELECTROLYTIC NICKEL LAYER
101: OPTICAL RECORDING MEDIUM
102: SUBSTRATE
102a: CONCAVE PIT
102b: SPACE
103: REFLECTIVE LAYER
103a: CONCAVE PORTION
103b: GAP BETWEEN CONCAVE PORTIONS
104: LIGHT TRANSMISSION LAYER
105: HARD COAT LAYER
113a: FILM FORMATION COMPLETION FACE
151: STAMPER
160: MOLD
170: OPTICAL RECORDING MEDIUM
172: SUBSTRATE
172a: CONVEX PIT
172b: SPACE
173: REFLECTIVE LAYER
173a: CONVEX PORTION
173b: GAP BETWEEN CONVEX PORTIONS
174: LIGHT TRANSMISSION LAYER
175: HARD COAT LAYER

### DETAILED DESCRIPTION OF THE PREFERRED EMBODIMENTS

### First Embodiment

Hereinafter, first embodiment of the invention will be described in detail with reference to the accompanying drawings.

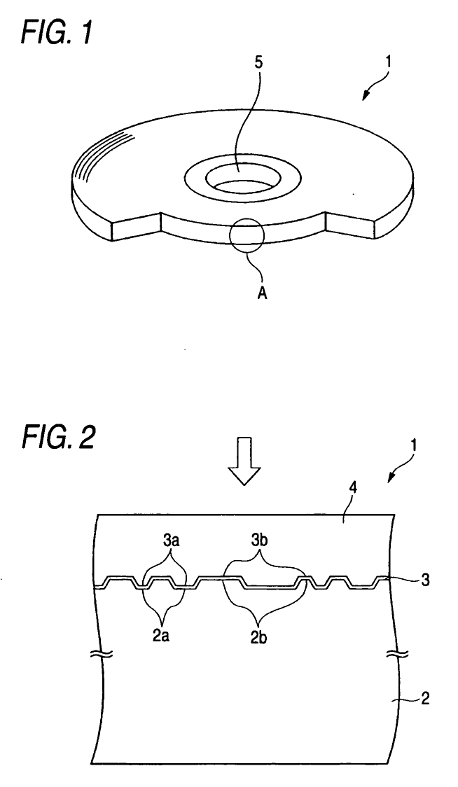

FIG. 1 is a schematic perspective view of a ROM-type optical recording medium related to a preferred embodiment of the invention, and FIG. 2 is a schematic enlarged sectional view of a portion indicated by A in FIG. 1.

As shown in FIG. 1, an optical recording medium 1 is formed into a disc shape, and has a center hole 5 for setting the optical recording medium 1 in the data reproducing device formed at its center.

The optical recording medium 1 shown in FIGS. 1 and 2 is adapted to be irradiated with a laser beam having a wavelength of 380 nm to 450 nm from the direction indicated by an arrow in FIG. 2 via an objective lens (not shown) to reproduce data.

As shown in FIG. 2, the optical recording medium 1 related to the present embodiment includes a substrate 2, a reflective layer 3 formed on the substrate 2, and a light transmission layer 4 formed on the reflective layer 3.

The substrate 2 functions as a mechanical support for the optical recording medium 1.

A material for forming the substrate 2 is not particularly limited as long as it can function as the support for the optical recording medium 1. For example, polycarbonate resin, olefin resin or the like can be used for the material for forming the substrate. Although the thickness of the substrate 2 is not particularly limited, it is preferably about 1.1 mm.

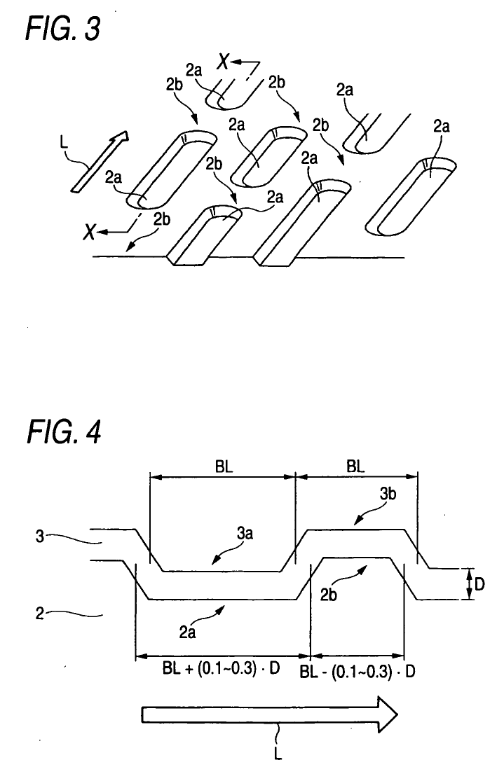

FIG. 3 is a schematic perspective view of the surface of the substrate 2. In FIG. 3, an arrow L indicates a scanning direction of a laser beam.

As shown in FIG. 3, a plurality of concave pits 2a having a substantially elliptical shape is formed on the surface of the substrate 2. The plurality of concave pits 2a is spirally formed from the inner periphery of the optical recording medium 1 toward the outer periphery thereof or from the outer periphery of the optical recording medium to the inner periphery thereof, thereby constituting tracks. Further, the other region than the plurality of concave pits 2a is formed flat, and spaces 2b are formed between the concave pits 2a adjacent to each other in the track direction. ‘0’ or ‘1’ of digital data is caused to correspond to the concave pits 2a and the spaces 2b and data is recorded by the concave pits 2a and the spaces 2b.

As shown in FIG. 2, the reflective layer 3 is formed on the substrate 2.

The reflective layer 3 has a function to reflect an incident laser beam through the light transmission layer 4 and emit the reflected laser beam from the light transmission layer 4.

In the present embodiment, a material for forming the reflective layer 3 is not particularly limited as long as it can reflect a laser beam. The reflective layer 3 can be formed of, for example, at least one kind of metal selected from a group consisting of Mg, Al, Ti, Cr, Fe, Co, Ni, Cu, Zn, Ge, Ag, Pt, Au, Nd, In and Sn or alloys thereof. Among these, when the reflective layer 3 is formed of Ag or an Ag-contained alloy, the reflective layer 3 having a high reflectance and an excellent surface flatness can be formed, which is preferable.

Although the thickness of the reflective layer 3 is particular limited, it is preferably 5 nm to 100 nm and more preferably 15 nm to 60 nm.

The reflective layer 3 is formed on the substrate 2 by a vapor deposition method such as sputtering. According to the vapor deposition method such as sputtering, since ions accelerated in an electric field is caused to collide against a target to eject atoms out of the target, and the ejected atoms are deposited to form a thin film, the surface shape of a base substrate to be a base is transferred to the formed thin film. Accordingly, the surface shape of the substrate 2 is transferred to the reflective layer 3, whereby concave portions 3a corresponding to the concave pits 2a on the surface of the substrate 2 are formed on the reflective layer 3.

As shown in FIG. 2, the light transmission layer 4 is formed on the reflective layer 3.

The light transmission layer 4 is a layer through which a laser beam is transmitted, and at the same time, serves as a protective layer for protecting the surface of the reflective layer 3.

The light transmission layer 4 is required to be optically transparent, show a low optical absorptance and reflectance in 380 nm to 450 nm that is the wavelength range of a laser beam to be used, and have a low birefringence, and is formed of, for example, UV curable resins.

The UV curable resins used for forming the light transmission layer 4 contain photopolymerizable monomers, photopolymerizable oligomers, photoinitiators, and as desired, other additives. The photopolymerizable monomers include, preferably, monomers having a molecular weight of less than 2000, for example, monofunctional (meth) acrylates, multifunctional (meth) acrylates, etc. Also, the photopolymerizable oligomers may include oligomers which contain or introduce, in molecules, groups which are cross-linked or polymerized by irradiation with UV rays, such as acrylic double bonds, allylic double bonds, and unsaturated double bonds. Also, as the photoinitiators, any one of known initiators may be used, for example, molecular cleavage type photopolymerization initiators can be used.

The light transmission layer 4 is formed by coating a UV curable resin on the surface of the reflective layer 3 by a spin coating method, etc. to form a coated film, and then irradiating the coated film with UV rays to cure the UV curable resin. Alternatively, the light transmission layer 4 can be formed by bonding a sheet formed of a light transmissive resin using an adhesive to the surface of the reflective layer 3.

The thickness of the light transmission layer 4 is preferably 30 μm to 200 μm.

FIG. 4 is a sectional view taken along an axis X-X in FIG. 3, and a schematic enlarged sectional view showing the sectional shape of the surface of the substrate 2 and the surface of the reflective layer 3. In FIG. 4, an arrow L indicates a scanning direction of a laser beam.

As shown in FIG. 4, the concave pits 2a are formed on the surface of the substrate 2. Further, concave portions 3a are formed on the reflective layer 3 correspondingly to the concave pits 2a formed on the surface of the substrate 2.

Even in a case where the concave pits 2a and the spaces 2b are formed on the substrate 2 correspondingly to data to be recorded, when the data recorded on next-generation ROM-type optical recording media is reproduced, jitter characteristics of reproducing signals may deteriorate. According to the studies of the inventors, it was found that this is because the length of the concave portions 3a of the reflective layer 3 is smaller than that of the concave pits 2a formed on the surface of the substrate 2, and the length of gaps 3b between the adjacent concave portions 3a is larger than that of the spaces 2b formed on the surface of the substrate 2, as a result of that the length of the concave portions 3a of the reflective layer 3 and the length of the gaps 3b between the adjacent concave portions 3a are detected by a photodetector, and therefore the length of a concavo-convex pattern recognized by a data reproducing device does not coincides with the length corresponding to the recorded data.

Therefore, based on such knowledge, the inventors vigorously pursued the studies and as a result, made the following discovery that in a case where the concave pits 2a of the surface of the substrate 2 is formed to be larger than the basic length BL by a length of (0.1 to 0.3)·D, and the spaces 2b between the concave pits 2a adjacent to each other in the track direction are formed to be smaller than the basic length BL by a length of (0.1 to 0.3)·D, it is possible to make the length of the gap 3b between the concave portions 3a formed on the reflective layer 3 almost equal to the basic length BL that is the length corresponding to data to be recorded.

Accordingly, in the present embodiment, the concave pits 2a to be formed on the surface of the substrate 2 are formed to be larger than the basic length BL by a length of (0.1 to 0.3)·D, and the spaces 2b between the concave pits 2a adjacent to each other in the track direction are formed to be smaller than the basic length BL by a length of (0.1 to 0.3)·D.

Here, D is a distance from the surface of the reflective layer 3 to the surface of the substrate 2, and in the present embodiment, is the thickness of the reflective layer 3. Further the basic length BL is a length which is determined according to the bit number of ‘0’ or ‘1’ of data to be recorded. For example, when data of 2 T or 8 T which has been modulated by 1-7RLL modulation is recorded on the optical recording medium 1 in a recording capacity of 25 GB, the data has seven types of length of 149 nm, 223.5 nm, 298 nm, 372.5 nm, 447 nm, 521.5 nm, and 596 nm correspondingly to 2 T or 8 T.

Accordingly, in the present embodiment, when data of 2 T or 8 T which has been modulated by 1-7RLL modulation is recorded, the data is formed by combining concave pits 2a having seven types of length among which the shortest length is 149+(0.1 to 0.3)·D nm, and the longest length is 596+(0.1 to 0.3)·D nm, with spaces 2b having seven types of length among which the shortest length is 149−(0.1 to 0.3)·D nm and the longest length is 596−(0.1 to 0.3)·D nm, on the surface of the substrate 2, in predetermined combinations.

In the present embodiment, since the concave portions 3a on the reflective layer 3 and the gap 3b between the concave pits 3a have the same length therebetween as the basic length BL that is the length corresponding to data to be recorded, when the data recorded on the optical recording medium 1 is reproduced, the length of concavo-convex patterns to be detected by a photodetector becomes a length that is approximately equal to the length corresponding to the recorded data. Accordingly, reproducing signals having good jitter characteristics can be obtained, and data can be reproduced as desired.

The optical recording medium 1 having the construction as described above is manufactured in the following way.

In manufacturing the optical recording medium 1, first, a photoresist master for forming the substrate 2 is fabricated, and thereafter, a stamper is formed by a mastering process using the photoresist master.

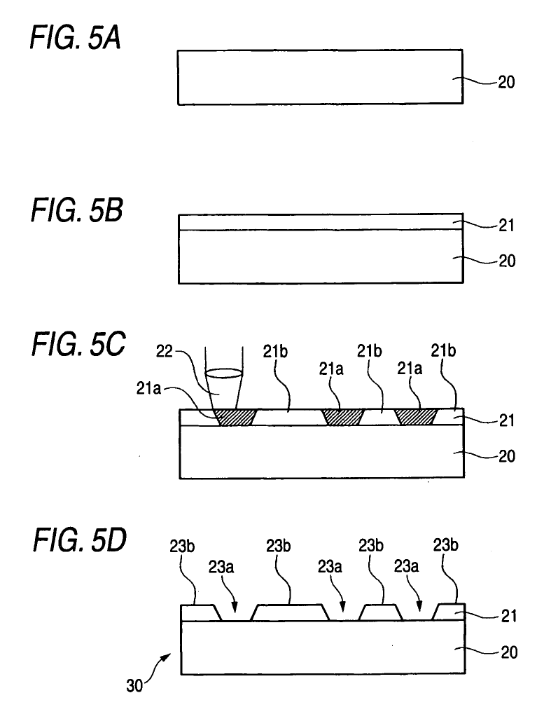

FIGS. 5A to 5D are flow charts showing the manufacturing process of the photoresist master for forming the substrate 2.

As shown in FIG. 5A, first, a glass substrate 20 which is polished and cleaned with precision is set on a spin coating device, and a coupling agent such as hexamethyldisilazane is coated on the surface of the glass substrate 20.

Next, the glass substrate 20 coated with the coupling agent is set on the spin coating device, and then a coating solution containing a photoresist using novolac resins or polystyrene resins as a major component is coated uniformly on the glass substrate 20 by a spin coating method, thereby forming a coated film.

Thereafter, the coated film is baked to a photoresist layer 21 on the glass substrate 20 as shown in FIG. 5B. The photoresist layer 21 is formed with a thickness corresponding to the depth of concave pits 2a to be formed on the surface of the substrate 2.

Next, the glass substrate 20 is set on a turntable within an exposure device, and as shown in FIG. 5C, the photoresist layer 21 is irradiated with a laser beam 22 for exposure while the glass substrate 20 is turned.

While the glass substrate 20 is turned, the laser beam 22 for exposure is irradiated while being moved from a center of the glass substrate 20 toward to an outer edge thereof along the radial direction of the glass substrate 20. Further, ON/OFF is switched according to data to be recorded, thereby controlling irradiation time and irradiation interval of the laser beam.

In this way, the surface of the photoresist layer 21 is intermittently irradiated with the laser beam 22 for exposure. As a result, exposed regions 21a corresponding to the concave pits 2a on the surface of the substrate 2 and non-exposed regions 21b corresponding to the spaces 2b on the surface of the substrate 2 are alternately formed on the photoresist layer 21.

Next, the glass substrate 20 formed with photoresist layer 21 is immersed in an alkaline solution, and the photoresist layer 21 is developed, thereby removing the exposed regions 21a. In the present embodiment, the glass substrate 20 formed with the photoresist layer 21 is immersed in an alkaline solution for a longer time than normally, so that the size of a region removed by the developing treatment increase.

Since the laser beam 22 for exposure is a Gaussian beam, the intensity of the laser beam 22 for exposure is the strongest in the central portion of a beam spot, and becomes weaker toward the peripheral edge of the beam spot. Accordingly, peripheral regions exposed by a low intensity portion of the laser beam 22 for exposure are formed on the exposed regions 21a of the photoresist layer 21, and other regions exposed by a strong intensity portion of the laser beam 22 for exposure.

In the present embodiment, as described above, since the glass substrate 20 formed with the photoresist layer 21 is immersed in an alkaline solution for a longer time than normally, during the developing treatment, the regions which have been exposed by the weak intensity portion of the laser beam 22 for exposure are also removed. As a result, the length of concave portions to be formed on the surface of a photoresist master 30 increases, and at the same time, the length of the gap between the adjacent concave portions decreases. Accordingly, as shown in FIG. 5D, concave pits 23a having a larger length than the basic length BL by a length of (0.1 to 0.3)·D, and spaces 23b having a smaller length than the basic length BL by a length of (0.1 to 0.3)·D are formed on the surface of the photoresist master 30.

When the photoresist master 30 is fabricated, then a stamper to which a concavo-convex pattern formed on the surface of photoresist master 30 is transferred is fabricated, and a substrate 2 of an optical recording medium 1 is fabricated.

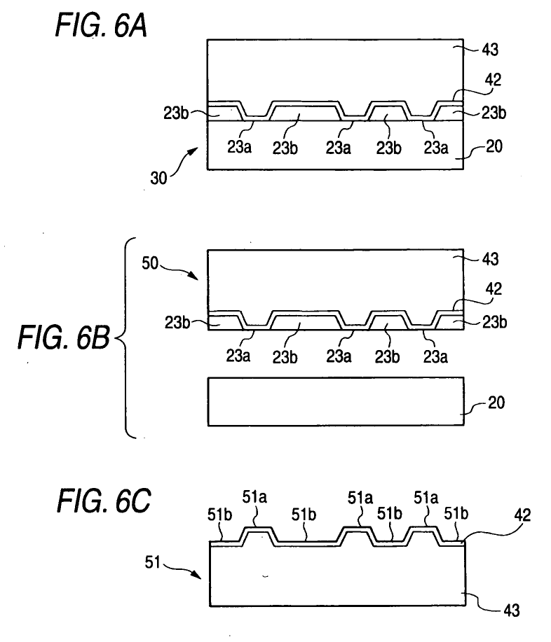

FIGS. 6A to 6C are a flow chart showing the manufacturing process of a stamper.

In manufacturing a stamper, first, chemicals containing palladium (Pd) chloride and stannum (Sn) chloride are coated to cover all the concave pits 23a and the spaces 23b which are formed on the surface photoresist master 30.

Thereafter, the photoresist master 30 is immersed in a hydroborofluoric acid solution to remove Sn attached to the photoresist master 30, and the surface of the photoresist master 30 is cleaned with pure water to form a Pd base on the photoresist master 30.

Next, the photoresist master 30 formed with the Pd base is immersed in a solution containing Ni ions, and as shown in FIG. 6A, an electroless nickel layer 42 is formed on the photoresist master 30 by an electroless plating method. Thereafter, an electrolytic nickel layer 43 is formed on the electroless nickel layer 42 by electrolytic plating which uses the electroless nickel layer 42 as an electrode.

When the electrolytic nickel layer 43 has been formed in that way, as shown in FIG. 6B, a laminate 50 composed of the electroless nickel layer 42 and the electrolytic nickel layer 43 is integrally peeled off from the glass substrate 20. Thereafter, the laminate 50 is immersed in an alkaline solution, and thus the photoresist is solved and removed.

Further, the laminate 50 from which the photoresist has been removed is dried, and thus as shown in FIG. 6C, a stamper 51 having convex pits 51a and spaces 51b is fabricated.

In the present embodiment, since the concave pits 23a having a larger length than the basic length BL by a length of (0.1 to 0.3)·D, and the spaces 23b having a smaller length than the basic length BL by a length of (0.1 to 0.3)·D are formed on the surface of the photoresist master 30, the convex pits 51a having a larger length than the basic length BL by a length of (0.1 to 0.3)·D, and the spaces 51b having a smaller length than the basic length BL by a length of (0.1 to 0.3)·D are formed on the surface of the stamper 51.

When the stamper 51 has been formed, a substrate 2 of an optical recording medium 1 is fabricated using the stamper 51.

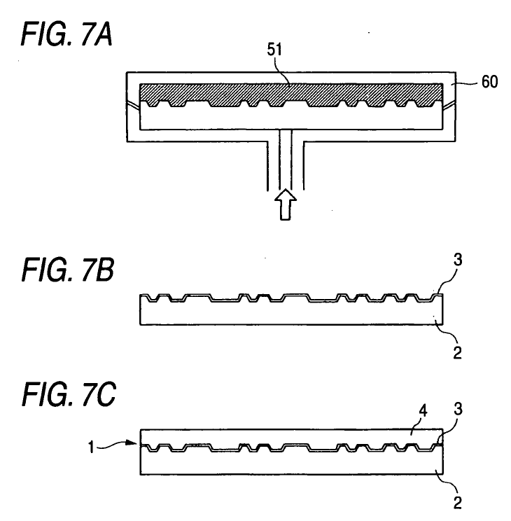

FIG. 7 is a flow chart showing the manufacturing process of an optical recording medium 1.

First, as shown in FIG. 7A, the stamper 51 is set in a mold 60. Thereafter, the mold 60 is set on an injection molding machine, and then melted polycarbonate resin is injected into the mold 60 at a high pressure.

Thereafter, the polycarbonate resin is cured for a predetermined cooling period.

In this way, as shown in FIG. 7B, a substrate 2 on which the concave pits 2a having a larger length than the basic length BL by a length of (0.1 to 0.3)·D, and the spaces 2b having a smaller length than the basic length BL by a length of (0.1 to 0.3)·D are formed is fabricated.

Next, the substrate 2 is set on a sputtering device, and as shown in FIG. 7B, a reflective layer 3 is formed on the surface of the substrate 2 by a sputtering method.

Finally, the substrate 2 on which the reflective layer 3 has been formed is set on the spin coating device, and then as shown in FIG. 7C, a light transmission layer 4 is formed on the surface of the reflective layer 3 by the spin coating method, thereby completing an optical recording medium 1.

According to the present embodiment, since the concave pits 2a formed on the surface of the substrate 2 is formed to be larger than the basic length BL by a length of (0.1 to 0.3)·D, and the spaces 2b adjacent to each other in the track direction is formed to be shorter than the basic length BL by a length of (0.1 to 0.3)·D, the length of the concave portions 3a formed on the reflective layer 3 and the length of the gap 3b between the concave portions 3a can be made approximately equal to the basic length BL. Accordingly, since the length of a concavo-convex pattern detected by a photodetector is approximately equal to the length corresponding to the recorded data when the data recorded on the optical recording medium 1 is recorded, reproducing signals having good jitter characteristics can be obtained, which makes it possible to reproduce the data as desired.

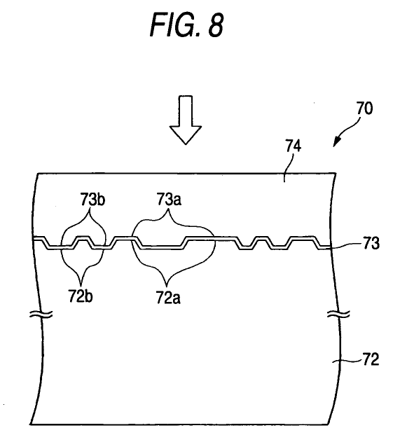

FIG. 8 is an enlarged sectional view of a ROM-type optical recording medium related to another preferred embodiment of the invention.

As shown in FIG. 8, an optical recording medium 70 related to the present embodiment has almost the same construction as the optical recording medium 1 shown in FIG. 2 except that it includes a substrate 72, a reflective layer 73 formed on the substrate 72, and a light transmission layer 74 formed on the reflective layer 73, and the convex pits 72a are formed to record data.

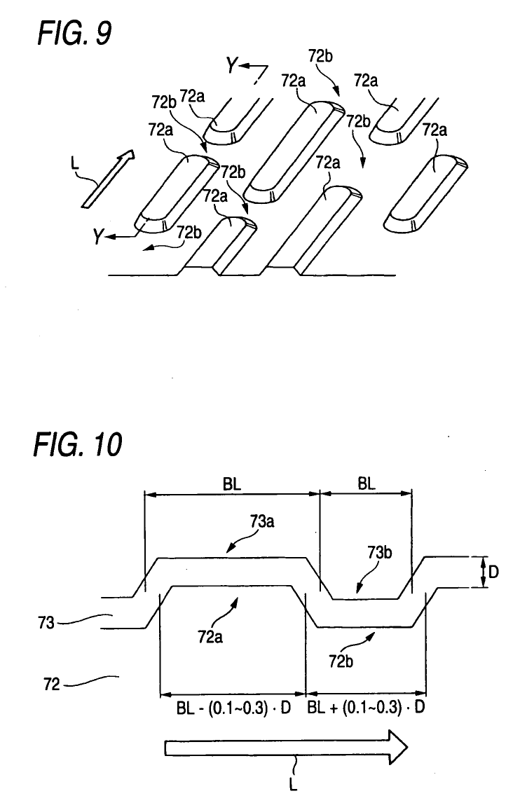

FIG. 9 is a schematic perspective view of the surface of the substrate 72, and FIG. 10 is a sectional view taken along an axis Y-Y of FIG. 9. Both arrows L in FIGS. 9 and 10 indicate the scanning direction of a laser beam.

As shown in FIG. 9, the surface of the substrate 72 is formed with a plurality of elliptical convex pits 72a. The plurality of convex pits 72a are spirally formed from the inner periphery of the optical recording medium 70 toward the outer periphery thereof or from the outer periphery of the optical recording medium toward the inner periphery thereof, thereby constituting tracks. Further, a region other than the plurality of convex pits 72a is formed flat, thereby forming spaces 72b between the convex pits 72a adjacent to each other in the track direction. ‘0’ and ‘1’ of digital data are caused to correspond to the convex pits 72a and the spaces 72b, and data are recorded by the convex pits 72a and the spaces 72b.

In the present embodiment, as shown in FIG. 10, the convex pits 72a on the surface of the substrate 72 are formed to be shorter than the basic length BL by a length of (0.1 to 0.3)·D, while the spaces 72b between the convex pits 72a adjacent to each other in the track direction are formed to be longer than the basic length BL by (0.1 to 0.3)·D.

In the present embodiment, D is also a distance from the surface of the reflective layer 73 to the surface of the substrate 72, and the basic length BL is a length which is determined correspondingly to the bit number of ‘0’ or ‘1’.

If the convex pits 72a and the spaces 72b on the surface of the substrate 72 has such a length, the length of convex portions 73a formed on the reflective layer 73 and the length of the gap 73b between the convex portions 73a can be made equal to the basic length BL that is the length corresponding to data to be recorded. Also, when the data recorded on the optical recording medium 70 is reproduced, the length of concavo-convex patterns to be detected by a photodetector can be respectively made approximately equal to the length corresponding to the recorded data. Accordingly, reproducing signals having good jitter characteristics can be obtained, and thus the data can be reproduced as desired.

The optical recording medium 70 having the construction as described above is manufactured in the following way.

In manufacturing the optical recording medium 70, first, a photoresist master is manufactured.

In the present embodiment, in manufacturing a photoresist master, first, a glass substrate formed with a photoresist layer is immersed in an alkaline solution for a shorter time than normally. As a result, on the surface of a photoresist master, concave pits having a smaller length than the basic length BL by a length of (0.1 to 0.3)·D, and spaces having a larger length than the basic length BL by a length of (0.1 to 0.3)·D are formed.

When the photoresist master has been formed, then a master stamper is fabricated through a mastering process.

In the present embodiment, as described above, since the concave pits having a smaller length than the basic length BL by a length of (0.1 to 0.3)·D, and the spaces having a larger than the basic length BL by the (0.1 to 0.3)·D are formed on the surface of the photoresist master, convex pits having a smaller length than the basic length BL by a length of (0.1 to 0.3)·D and spaces having a larger length than the basic length BL by a length of (0.1 to 0.3)·D can be formed on the surface of the master stamper.

When the master stamper is fabricated in this way, a mother stamper is fabricated through a mastering process from the master stamper.

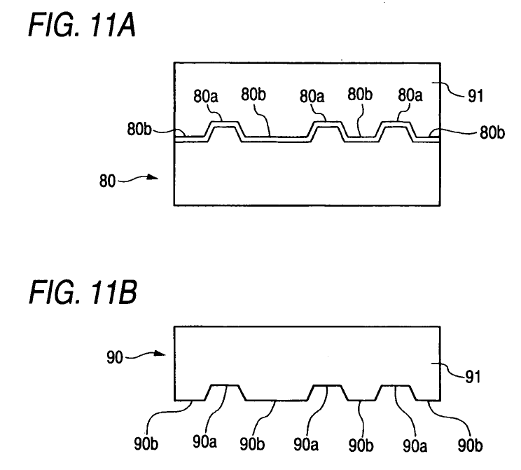

FIGS. 11A and 11B show the manufacturing process of a mother stamper according to a preferred embodiment of the invention.

First, the master stamper 80 is immersed in a potassium permanganate solution so that the surface of the master stamper 80 is subjected to an oxidation treatment. Next, the master stamper 80 which has been subjected to the oxidation treatment is immersed in an electrolytic nickel solution so that a metal film to be formed by electrolytic plating, and as shown in FIG. 11A, thereby forming an electrolytic nickel layer 91 on the surface of the master stamper 80.

Next, as shown in FIG. 1B, the electrolytic nickel layer 91 is peeled off from the master stamper 80, and thereafter, the center and outer periphery of the peeled electrolytic nickel layer 91 is punched out, whereby a mother stamper 90 is fabricated.

In the present embodiment, as described above, since convex pits 80a having a smaller length than the basic length BL by a length of (0.1 to 0.3)·D and spaces 80b having a longer length than the basic length BL by a length of (0.1 to 0.3)·D are formed on the surface of the master stamper 80, concave pits 90a having a smaller length than the basic length BL by a length of (0.1 to 0.3)·D and spaces 90b having a larger length than the basic length BL by a (0.1 to 0.3)·D are formed on the surface of the mother stamper 90.

When the mother stamper 90 has been fabricated, a substrate 72 is formed by injection molding after the mother stamper 90 is set in a mold. In this way, the substrate 72 composed of the convex pits 72a having a smaller length than the basic length BL by a length of (0.1 to 0.3)·D and the spaces 72b having a larger length than the basic length BL by a length of (0.1 to 0.3)·D is fabricated.

Thereafter, a reflective layer 73 and a light transmission layer 74 are formed sequentially on the surface of the substrate 72, whereby the optical recording medium 70 are completed.

The invention is not limited to the above embodiments and can be modified in various ways within the scope of the appended claims, and such modifications are also included in the present invention.

For example, although the optical recording medium 1 or 70 shown in FIG. 2 and FIG. 8 has been described in conjunction with the construction in which the reflective layer 3 or 73 is formed on the surface of the substrate 2 or 72, the reflective layer 3 or 73 is not necessarily formed on the surface of the substrate 2 or 72, but one or more other layers may be interposed between the substrate 2 or 72 and the reflective layer 3 or 73. In this case, a total sum of the thickness of layers to be interposed between the substrate 2 or 72 and the reflective layer 3 or 73 and the thickness of the reflective layer 3 or 73 becomes the distance D from the surface of the reflective layer 3 or 73 to the surface of the substrate 2 or 72.

Further, although the optical recording medium 1 or 70 shown in FIG. 2 and FIG. 8 has been described in conjunction with the construction in which the transmission layer 4 or 74 is formed on the surface reflective layer 3 or 73, the transmission layer 4 or 74 is not necessarily formed on the surface of the reflective layer 3 or 73, but one or more other layers may be interposed between the reflective layer 3 or 73 and the transmission layer 4 or 74.

Moreover, although the preferred embodiments shown in FIGS. 5 to 7 have been described with respect to the construction in which the substrate 2 of the optical recording medium 1 is fabricated after setting the stamper 51 having the surface shape of the photoresist master 30 transferred thereto in a mold, it is not necessarily required that the substrate 2 of the optical recording medium 1 is fabricated after setting the stamper 51 having the surface shape of the photoresist master 30 transferred thereto in a mold, but the substrate 2 of the optical recording medium 1 may be fabricated by fabricating a mother stamper and a child stamper from the stamper 51 as a mother stamper, and then setting the child stamper thereof in a mold.

Further, although the above embodiments have been described in conjunction with the construction in which the length of concave pits and spaces or the length of convex pits and spaces are adjusted by controlling the time for which a glass substrate formed with a photoresist layer is immersed in an alkaline solution, instead of controlling the time for which a glass substrate formed with a photoresist layer is immersed in an alkaline solution, for example, the length of concave pits and spaces or the length of convex pits and spaces are adjusted by controlling irradiation time of a laser beam for exposure to adjust the length of exposed regions.

### Second Embodiment

Hereinafter, second embodiment of the invention will be described in detail with reference to the accompanying drawings.

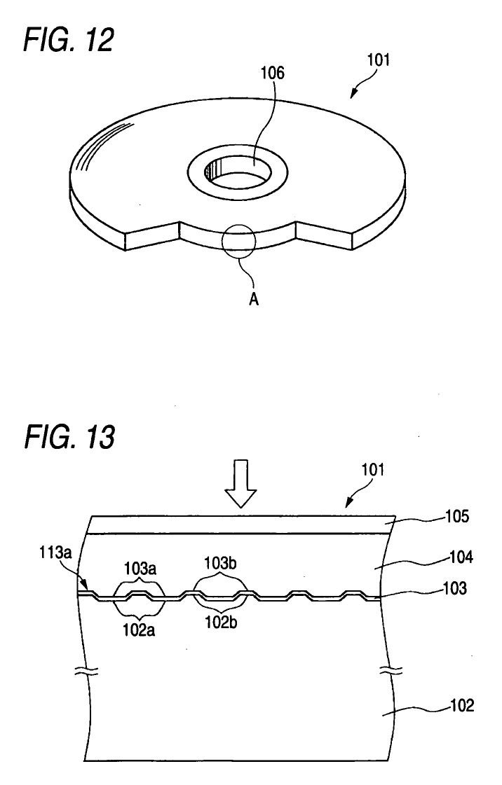

FIG. 12 is a partially cutaway perspective view showing the outline of a ROM-type optical recording medium having concave pits on a substrate, related to a preferred embodiment of the invention, and FIG. 13 is a schematic enlarged sectional view of a portion indicated by A in FIG. 12.

As shown in FIG. 1, an optical recording medium 101 is formed into a disc shape, and has a center hole 106 for setting the optical recording medium 101 in the data reproducing device formed at its center.

The optical recording medium 101 shown in FIGS. 12 and 13 is adapted to be irradiated with a laser beam having a wavelength of 380 nm to 450 nm from the direction indicated by an arrow in FIG. 13 via an objective lens (not shown) to reproduce data.

As shown in FIG. 13, the optical recording medium 101 related to the present embodiment includes a substrate 102, a reflective layer 103 formed on the substrate 102, a light transmission layer 104 formed on the reflective layer 103, and a hard coat layer 105 formed on the light transmission layer 104.

The substrate 102 functions as a mechanical support for the optical recording medium 101. A material for forming the substrate 102 is not particularly limited so long as it can function as the support for the optical recording medium 101. For example, polycarbonate resin, olefin resin or the like can be used for the material for forming the substrate. Although the thickness of the substrate 102 is not particularly limited, it is preferably about 1.1 mm.

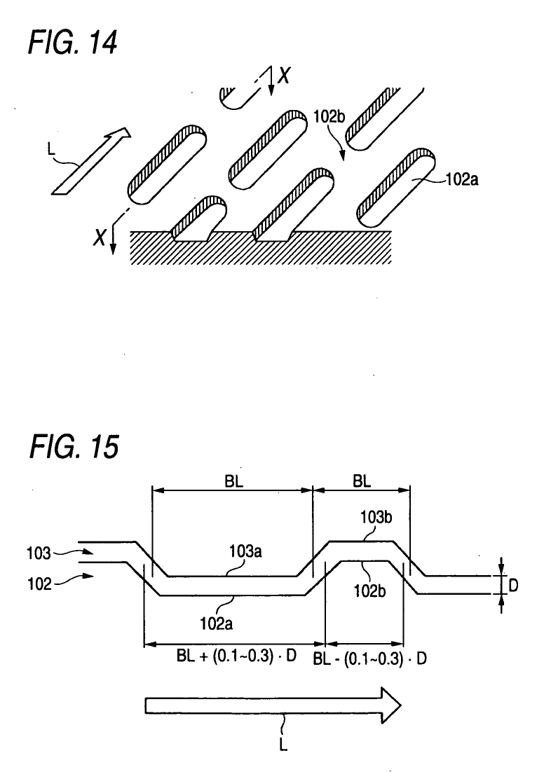

FIG. 14 is a schematic perspective view of the surface of the substrate 2. In FIG. 14, an arrow L indicates a scanning direction of a laser beam.

As shown in FIG. 14, a plurality of concave pits 102a having a substantially elliptical shape is formed on the surface of the substrate 102. The plurality of concave pits 102a is spirally formed from the inner periphery of the optical recording medium 101 toward the outer periphery thereof or from the outer periphery of the optical recording medium to the inner periphery thereof, thereby constituting tracks. Further, the other region than the plurality of concave pits 102a is formed flat, and spaces 102b are formed between the concave pits 102a adjacent to each other in the track direction. ‘0’ or ‘1’ of digital data is caused to correspond to the concave pits 102a and the spaces 102b and data is recorded by the concave pits 102a and the spaces 102b.

As shown in FIG. 13, the reflective layer 103 is formed on the substrate 102.

The reflective layer 103 has a function to reflect a laser beam incident through the hard coat layer 105 and the light transmission layer 104 and emit the reflected laser beam from the hard coat layer 105, and servers to rapidly radiate heat caused by the laser beam. As a result, since the optical reflectance is high, the reproducing characteristics can be improved. Accordingly, although it is necessary that a material having a high reflectance in the wavelength range (380 nm to 450 nm) concerned is selected as the material for reflective layer 103, it is desirable that a material which places minimal burden on the global environment rather is selected without being limited for thermal conductivity because the optical recording medium 1 related to the present embodiment performs only reproducing.

As will be described later, since the optical recording medium 101 related to the present embodiment is a next-generation ROM-type optical recording medium in which films are sequentially formed from the opposite side to the light incident side, the surface of a reflective layer at the light incident side tends to become rough, as compared to optical recording media of type in which films are sequentially from the light incident side, such as CDs or DVDs. This is because a film formation start face of the surface of a reflective layer is located at the light incident side in the optical recording media of type in which films are sequentially formed from the light incident side, such as CDs or DVDs, so that the surface property of the reflective layer is almost the same as the surface property of a base, while a film formation completion face 113a of the surface of the reflective layer 103 is located at the light incident side as in the next-generation optical recording medium 101 in which films are sequentially formed from the opposite side to the light incident side, so that the surface property of the reflective layer deteriorates due to crystal growth during film formation. Accordingly, as the material for forming the reflective layer 103 related to the invention, it is necessary to select a material having an excellent surface property in the film formation completion face 113a.

In consideration of the above points, in the present embodiment, a material that contains aluminum (Al) as a main component and has additive added thereto is used as the material for forming the reflective layer 103. Since aluminum (Al) has a sufficiently high reflectance for a laser beam having a wavelength of 380 nm to 450 nm, the optical reflectance for the laser beam L can be increased, so that desired high reproducing characteristics can be obtained. Further, the optical recording medium has advantages which are excellent in cost and storage reliability.

As the additive that are added to aluminum (Al), magnesium (Mg), silicon (Si), titan (Ti), ferrum (Fe), copper (Cu), zinc (Zn), germanium (Ge), tantalum (Ta), tungsten (W), palladium (Pd), silver (Ag), platinum (Pt) and gold (Au) are preferably used. Among these, magnesium (Mg) and tungsten (W) are particularly preferable. Since the addition of those additive allows the reflective layer 103 to have a more improved surface property than a case in which a reflective layer is composed of pure aluminum (Al), it is possible to improve the surface property in the film formation completion face 113a of the reflective layer 103 even when film are sequentially formed from the opposite side to the light incident side as in the optical recording medium 101 related to the present embodiment.

In addition, the smaller the diameter of a beam spot of a laser beam irradiated onto the film formation completion face, the greater the effect that the surface property of the film formation completion face 113a of the reflective layer 103 has on signal characteristics. This is because as the diameter of a beam spot increases, irregularities included in the beam spot increased, so that the effect of the surface property on actual signal characteristics is lowered. Specifically, when it is assumed that the wavelength of a laser beam is λ and the numerical aperture of an objective lens for focusing the laser beam is NA, if λ/NA>640 nm, the surface property in the film formation completion face 113a of the reflective layer 103 does not have a substantial effect on actual signal characteristics. In contrast, if λ/NA≦640 nm, the surface property in the film formation completion face 113a of the reflective layer 103 has a substantial effect on actual signal characteristics. Therefore, the provision of the above-mentioned elements to aluminum (Al) can reduce such substantial effect.

In other words, if λ/NA>640 nm, it is unnecessary to improve such a surface property. Similarly, since a film formation start face is located at the light incident side in optical recording media of type in which films are sequentially formed from the light incident side, such as DVDs, the surface property rarely depends on a material. Accordingly, it is almost unnecessary to improve a surface property in a film formation completion face unlike the present embodiment.

Preferably, the amount of an additive to be added is equal to or greater than 5 atm %. This is because if the amount of an additive is less than 5 atm %, the improvement effect of a surface property cannot be sufficiently obtained. In addition, since the main component of the reflective layer 103 is aluminum (Al), the amount of an additive is required to be 50 atm %. If the amount of the additive exceeds 50 atm %, there is a fear that the reflectance for laser beam L becomes insufficient.

When magnesium (Mg) is used as an additive, the above-described improvement effect of a surface property can be most remarkably obtained. If an element to be added is magnesium (Mg), the added amount of the element is preferably set to about 15 to 40 atm %, and more preferably set to about 30 atm %. The setting of the added amount of magnesium (Mg) to 15 to 40 atm % makes it possible to sufficiently obtain the improvement effect of a surface property without greatly lowering reflectance. Further, the setting of the added amount of magnesium (Mg) to about 30 atm % allows the reflectance and the improvement effect of a surface property to be most preferably compatible with each other.

Further, the above-described improvement effect of a surface property can be remarkably obtained even when tungsten (W) is added. When an element to be added is tungsten (W), the added amount thereof is preferably set to 5 to 16 atm %, and more preferably set to about 10 atm %. The setting of the added amount to 5 to 16 atm % makes it possible to obtain the improvement effect of a surface property without lowering reflectance. Further, the setting of the added amount of tungsten (W) to about 10 atm % allows the reflectance and the improvement effect of a surface property to be most preferably compatible with each other.

Moreover, one kind of element is not necessarily used as the additive, but two or more kinds of elements may be used as the additive. When two kinds of elements are added, it is preferable to select magnesium (Mg) and tungsten (W) as the additive. In this case, the added amount of magnesium (Mg) is preferably set to 10 atm % or more, and the added amount of tungsten (W) is more preferably set to about 5 atm %. The above setting of the added amount of magnesium (Mg) and the added amount of tungsten (W) make is possible to more remarkably obtain the improvement effect of a surface property as compared to the case in which magnesium (Mg) or tungsten (W) is added independently.

The thickness of the reflective layer 103 is preferably set to 5 to 300 nm and more preferably set to 20 to 200 nm. This is because if the thickness of the reflective layer 103 is less than 5 nm, the above-described effects by virtue of the reflective layer 103 cannot be sufficiently obtained, whereas if the thickness of the reflective layer 103 exceeds 300 nm, not only the surface property of the film formation completion face 113a of the reflective layer 103 may deteriorate, but also the productivity of the optical recording medium may decrease. If the thickness of the reflective layer 103 is set to 5 to 300 nm, particularly, 20 to 200 nm, the above-described effects by virtue of the reflective layer 103 can be sufficiently obtained, the surface property of the film formation completion face 113a can be maintained and a decrease in productively can be prevented.

The reflective layer 103 is formed on the substrate 102 by a vapor deposition method such as sputtering. According to the vapor deposition method such as sputtering, since ions accelerated in an electric field are caused to collide against a target to eject atoms out of the target, and the ejected atoms are deposited to form a thin film, the surface shape of a base substrate to be a base is transferred to the formed thin film. Accordingly, the surface shape of the substrate 102 is transferred to the reflective layer 103, whereby concave portions 103a corresponding to the concave pits 102a on the surface of the substrate 102 are formed on the reflective layer 103.

As shown in FIG. 13, the light transmission layer 104 and the hard coat layer 105 are sequentially formed on the reflective layer 103. The transmission layer 104 is a layer through which a laser beam is transmitted, and at the same time, serves as a protective layer for protecting the surface of the reflective layer 103.

The light transmission layer 104 is required to be optically transparent, show a low optical absorptance and reflectance in 380 nm to 450 nm that is the wavelength range of a laser beam to be used, and have a low birefringence, and is formed of, for example, UV curable resins.

The UV curable resins used for forming the light transmission layer 4 contain photopolymerizable monomers, photopolymerizable oligomers, photoinitiators, and as desired, other additives. As the photopolymerizable monomers include, preferably, monomers having a molecular weight of less than 2000, for example, monofunctional (meta) acrylates, multifunctional (meta) acrylates, etc. Also, the photopolymerizable oligomers may include oligomers which contain or introduce, in molecules, groups which are cross-linked or polymerized by irradiation with UV rays, such as acrylic double bonds, allylic double bonds, and unsaturated double bonds. Also, as the photoinitiators, any one of known initiators may be used, for example, molecular cleavage type photopolymerization initiators can be used.

The light transmission layer 104 is formed by coating a UV curable resin on the surface of the reflective layer 103 by a spin coating method, etc. to form a coated film, and then irradiating the coated film with UV rays to cure the UV curable resin. Alternatively, the light transmission layer 104 can be formed by bonding a sheet formed of a light transmissive resin using an adhesive to a surface of the reflective layer 103. The thickness of the light transmission layer 104 is preferably 30 μm to 200 μm.

The hard coat layer 105 has a function to protect the optical recording medium 101 and allow the optical recording medium 101 to be used without being accommodated in a cartridge. In the invention, the hard coat layer may be provided, as desired.

In the invention, the surface of the hard coat layer 105 preferably has a hardness of B or more in a pencil hardness test. Further, the thickness of the hard coat layer 105 is preferably 0.5 to 5 μm. When a hard coat layer is formed on the surface of the light transmission layer 104, the total thickness thereof is preferably is 70 to 150 μm.

As the material for forming the hard coat layer 105, an activation energy ray-curable resin may be desirably used. For example, the material for forming the hard coat layer is not particularly limited as long as it includes compounds that have at least one reactive group selected from the group consisting of the (meth) acryloyl group, vinyl group, and mercapto group.

In the invention, the compounds that have the (meth) acryloyl group to be used for forming a hard coat layer includes, for example, trimethylolpropane tri(meth)acrylate, dipentaerythritolhexa(meth)acrylate, urethane(meth)acrylate, ester(meth)acrylate or the like.

In order to improve wear resistance, the hard coat layer 105 may include inorganic particles, such as silica particles, having a mean particle size of no less than 5 nm but no more than 100 nm, and preferably inorganic particles having a mean particle size of no less than 5 nm but no more than 20 nm.

The light transmission layer 104 or the hard coat layer 105 may include non-polymerizable diluting solvents, organic fillers, polymerization inhibitors, oxidation inhibitors, ultraviolet absorbers, light stabilizers, defoaming agents, leveling agents, lubricants, pigments, silicon compounds or the like, if necessary. Silicon-based compounds such as silicon may be used as the leveling agents or lubricants, and fluoric compounds may be used as the lubricants.

Similar to the light transmission layer 104, the hard coat layer 105 can be formed by a coating method such as a spin coating method or a method of bonding a sheet, which is formed in advance, onto the light transmission layer 104.

FIG. 15 is a sectional view taken in the thickness direction of the substrate along an axis X-X in FIG. 14, and a schematic enlarged sectional view showing the sectional shape of the surface of the substrate 102 and the surface of the reflective layer 103. In FIG. 15, an arrow L indicates a scanning direction of a laser beam.

As shown in FIG. 15, the concave pits 102a are formed on the surface of the substrate 102. Further, concave portions 103a are formed on the reflective layer 103 correspondingly to the concave pits 102a formed on the surface of the substrate 102.

Even in a case where the concave pits 102a and the spaces 102b are formed on the substrate 102 correspondingly to data to be recorded, when the data recorded on next-generation ROM-type optical recording media is reproduced, jitter characteristics of reproducing signals may deteriorate. According to the studies of the inventors, it was found that this is because the length of the concave portions 103a of the reflective layer 103 is smaller than that of the concave pits 102a formed on the surface of the substrate 102, and the length of gaps 103b between the adjacent concave portions 103a is larger than that of the spaces 102b formed on the surface of the substrate 102, as a result of that the length of the concave portions 103a of the reflective layer 103 and the length of the gaps 103b between the adjacent concave portions 103a are detected by a photodetector, and therefore the length of a concavo-convex pattern recognized by a data reproducing device does not coincides with the length corresponding to the recorded data.

Therefore, based on such knowledge, the inventors vigorously pursued the studies and as a result, made the following discovery that in a case where the concave pits 102a of the surface of the substrate 102 is formed to be larger than the basic length BL by a length of (0.1 to 0.3)·D, and the spaces 102b between the concave pits 102a adjacent to each other in the track direction are formed to be smaller than the basic length BL by a length of (0.1 to 0.3)·D, it is possible to make the length of the gap 103b between the concave portions 103a formed on the reflective layer 103 almost equal to the basic length BL that is the length corresponding to data to be recorded.

Accordingly, in the present embodiment, the concave pits 102a to be formed on the surface of the substrate 102 are formed to be larger than the basic length BL by a length of (0.1 to 0.3)·D, while the spaces 102b between the concave pits 102a adjacent to each other in the track direction are formed to be smaller than the basic length BL by a length of (0.1 to 0.3)·D.

Here, D is a distance from the surface of the reflective layer 103 to the surface of the substrate 102, and in the present embodiment, is the thickness of the reflective layer 103. Further the basic length BL is a length which is determined according to the bit number of ‘0’ or ‘1’ of data to be recorded. For example, when data of 2 T or 8 T which has been modulated by 1-7RLL modulation is recorded on the optical recording medium 1 in a recording capacity of 25 GB, the data has seven types of length of 149 nm, 223.5 nm, 298 nm, 372.5 nm, 447 nm, 521.5 nm, and 596 nm correspondingly to 2 T or 8 T.

Accordingly, in the present embodiment, when data of 2 T or 8 T which has been modulated by 1-7RLL modulation is recorded, the data is formed by combining concave pits 2a having seven types of length among which the shortest length is 149+(0.1 to 0.3)·D nm, and the longest length is 596+(0.1 to 0.3)·D nm, with spaces 2b having seven types of length among which the shortest length is 149−(0.1 to 0.3)·D nm and the longest length is 596−(0.1 to 0.3)·D nm, on the surface of the substrate 102, in predetermined combinations.

In the present embodiment, since the concave portions 103a on the reflective layer 103 and the gap 103b between the concave pits 103a have the same length therebetween as the basic length BL that is the length corresponding to data to be recorded, when the data recorded on the optical recording medium 101 is reproduced, the length of concavo-convex patterns to be detected by a photodetector becomes a length that is approximately equal to the length corresponding to the recorded data. Accordingly, reproducing signals having good jitter characteristics can be obtained, and data can be reproduced as desired.

In manufacturing the optical recording medium 101, first, a photoresist master for forming the substrate 102 is fabricated, and thereafter, a stamper is formed by a mastering process using the photoresist master.

In the present embodiment, first, concave pits having a larger length than the basic length BL by a length of (0.1 to 0.3)·D, and spaces having a smaller length than the basic length BL by a length of (0.1 to 0.3)·D are formed on the surface of the photoresist master. Next, convex pits having a larger length than the basic length BL by a length of (0.1 to 0.3)·D, and spaces having a smaller length than the basic length BL by a length of (0.1 to 0.3)·D are formed on the surface of the stamper by using the photoresist master. Thereafter, the substrate 102 of the optical recording medium 101 is fabricated using the stamper 151.

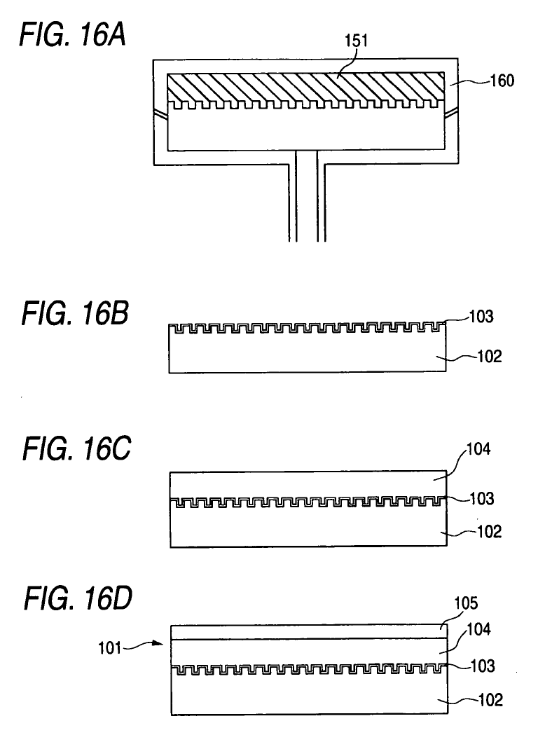

FIGS. 16A to 16D are flow charts showing the manufacturing process of an optical recording medium 101.

First, as shown in FIG. 16A, the stamper 151 is set in a mold 160. Thereafter, the mold 160 is set on an injection molding machine, and then melted polycarbonate resin is injected into the mold 160 at a high pressure.

Thereafter, the polycarbonate resin is cured for a predetermined cooling period.

In this way, as shown in FIG. 16B, a substrate 102 on which concave pits having a larger length than the basic length BL by a length of (0.1 to 0.3)·D, and spaces having a smaller length than the basic length BL by a length of (0.1 to 0.3)·D are formed is fabricated.

Next, the substrate 102 is set on a sputtering device, and as shown in FIG. 16B, a reflective layer 103 is formed on the surface of the substrate 102 by a sputtering method.

Next, the substrate 102 formed with the reflective layer 103 is set on a spin coating device, and as shown in FIG. 16C, a light transmission layer 104 is formed on the surface of the reflective layer 103 by a spin coating method.

Finally, the substrate 102 on which the light transmission layer 104 has been formed is set on the spin coating device, similar to the above, and then as shown in FIG. 16D, a hard coat layer 105 is formed on the surface of the light transmission layer 104 by the spin coating method, thereby completing an optical recording medium 101.

According to the present embodiment, since the concave pits 102a formed on the surface of the substrate 102 is formed to be larger than the basic length BL by a length of (0.1 to 0.3)·D, and the spaces 102b adjacent to each other in the track direction is formed to be shorter than the basic length BL by a length of (0.1 to 0.3)·D, the length of the concave portions 103a formed on the reflective layer 103 and the length of the gap 103b between the concave portions 103a can be made approximately equal to the basic length BL. Accordingly, since the length of a concavo-convex pattern detected by a photodetector is approximately equal to the length corresponding to the recorded data when the data recorded on the optical recording medium 1 is recorded, reproducing signals having good jitter characteristics can be obtained, which makes it possible to reproduce the data as desired.

Further, when the hard coat layer 105 is provided on the surface of the light transmission layer 104 as illustrated in the drawings, the wear resistance and the flaw resistance at the light incident side can be improved and thus the optical recording medium 1 can be used without being accommodated in a cartridge.

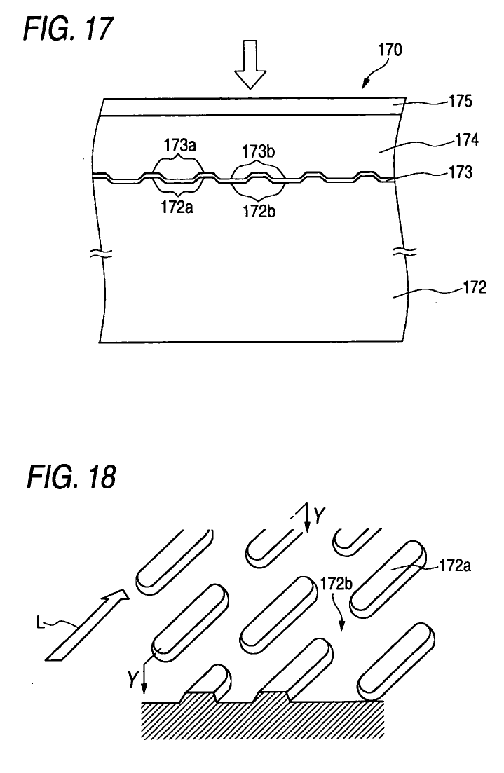

Next, FIG. 17 is an enlarged sectional view of a ROM-type optical recording medium having convex pits on a substrate, related to another preferred embodiment of the invention.

As shown in FIG. 17, an optical recording medium 170 related to the present embodiment includes a substrate 172, a reflective layer 173 formed on the substrate 172, and a light transmission layer 174 formed on the reflective layer 173, and a hard coat layer 175 formed on the light transmission layer 174. The optical recording medium 170 has completely the same construction as the optical recording medium 101 related to the afore-mentioned preferred embodiment shown in FIG. 13 except that convex pits 172a are formed to record data.

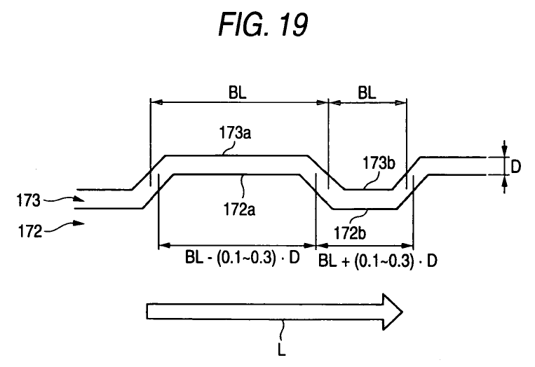

FIG. 18 is a schematic perspective view of the surface of the substrate 172, and FIG. 19 is a sectional view taken along an axis Y-Y of FIG. 18. Both arrows L in FIGS. 18 and 19 indicate the scanning direction of a laser beam.

As shown in FIG. 18, the surface of the substrate 172 is formed with a plurality of elliptical convex pits 172a. The plurality of convex pits 172a are spirally formed from the inner periphery of the optical recording medium 170 toward the outer periphery thereof or from the outer periphery of the optical recording medium toward the inner periphery thereof, thereby constituting tracks. Further, a region other than the plurality of convex pits 172a is formed flat, thereby forming spaces 172b between the convex pits 172a adjacent to each other in the track direction. ‘0’ and ‘1’ of digital data are caused to correspond to the convex pits 172a and the spaces 172b, and data are recorded by the convex pits 172a and the spaces 172b.

In the present embodiment, as shown in FIG. 19, the convex pits 172a on the surface of the substrate 172 are formed to be shorter than the basic length BL by a length of (0.1 to 0.3)·D, while the spaces 172b between the convex pits 172a adjacent to each other in the track direction are formed to be longer than the basic length BL by (0.1 to 0.3)·D.

In the present embodiment, D is also a distance from the surface of the reflective layer 173 to the surface of the substrate 172, and the basic length BL is a length which is determined correspondingly to the bit number of ‘0’ or ‘1’.

If the convex pits 172a and the spaces 172b on the surface of the substrate 172 has such a length, the length of convex portions 173a formed on the reflective layer 173 and the length of the gap 173b between the convex portions 173a can be made equal to the basic length BL that is the length corresponding to data to be recorded. Also, when the data recorded on the optical recording medium 170 is reproduced, the length of concavo-convex patterns to be detected by a photodetector can be respectively made approximately equal to the length corresponding to the recorded data. Accordingly, reproducing signals having good jitter characteristics can be obtained, and thus the data can be reproduced as desired.

In the present embodiment, in manufacturing a photoresist master, first, a photoresist master for forming a substrate 172 and thereafter a stamper is formed by a mastering process using the photoresist master.

In the present embodiment, after a mother stamper formed with concave pits having a smaller length than the basic length BL by a length of (0.1 to 0.3)·D and spaces having a longer length than the basic length BL by a length of (0.1 to 0.3)·D are set in a mold, a substrate 172 is formed by injection molding. In this way, the substrate 172 having convex pits 172a having a smaller length than the basic length BL by a length of (0.1 to 0.3)·D and spaces 172b having a larger length than the basic length BL by a (0.1 to 0.3)·D is fabricated.

Thereafter, a reflective layer 173 and a light transmission layer 174 and a hard coat layer 175 are formed sequentially on the surface of the substrate 172 in the same way as that in the afore-mentioned preferred embodiment, whereby the optical recording medium 170 are completed.

The invention is not limited to the above embodiments and can be modified in various ways. For example, although the optical recording medium 101 or 170 related to the preferred embodiments shown in FIG. 13 and FIG. 17 has been described in conjunction with the construction in which the reflective layer 103 or 173 is directly formed on the surface of the substrate 102 or 172, the reflective layer 103 or 173 is not necessarily formed on the surface of the substrate 102 or 172, but one or more other layers may be interposed between the substrate 102 or 172 and the reflective layer 103 or 173. In this case, a total sum of the thickness of layers to be interposed between the substrate 102 or 172 and the reflective layer 103 or 173 and the thickness of the reflective layer 103 or 173 becomes the distance D from the surface of the reflective layer 103 or 173 to the surface of the substrate 102 or 172.

Further, although the optical recording medium 101 or 170 related to the respective preferred embodiments shown in FIG. 13 and FIG. 17 has been described in conjunction with the construction in which the transmission layer 104 or 174 is directly formed on the surface reflective layer 103 or 173, the transmission layer 104 or 174 is not necessarily formed on the surface of the reflective layer 103 or 173, but one or more other layers may be interposed between the reflective layer 103 or 173 and the transmission layer 104 or 174.

1. A ROM-type optical recording medium adapted to reproduce data by causing a laser beam to be irradiated through a light transmission layer, comprising:
a substrate having a plurality of concave pits formed on a surface thereof;
the light transmission layer; and
a reflective layer formed between the substrate and the light transmission layer,
wherein the concave pits have a larger length than a basic length BL to be determined according to data to be recorded, and
the length of spaces between the concave pits adjacent to each other in a track direction has a smaller length than the basic length BL.

2. The ROM-type optical recording medium according to claim 1, wherein if a distance from a surface of the reflective layer to the surface of the substrate is assumed as D, the concave pits have a length of BL+(0.1 to 0.3)·D, and the spaces have a length of BL−(0.1 to 0.3)·D.

3. The ROM-type optical recording medium according to claim 1, wherein the reflective layer is formed of Ag or an alloy containing Ag.

4. The ROM-type optical recording medium according to claim 1, wherein the reflective layer is made of a material that contains aluminum (Al) as a main component and has an additive added thereto.

5. The ROM-type optical recording medium according to claim 1, wherein the additive contains at least one element selected from a group consisting of magnesium (Mg), silicon (Si), titan (Ti), ferrum (Fe), copper (Cu), zinc (Zn), germanium (Ge), tantalum (Ta), tungsten (W), palladium (Pd), silver (Ag), platinum (Pt) and gold (Au).

6. The ROM-type optical recording medium according to claim 1, further comprising a hard coat layer formed on a surface of the light transmission layer.

7. The ROM-type optical recording medium according to claim 6, wherein said hard coat layer including an activation energy ray-curable resin.

8. A ROM-type optical recording medium adapted to reproduce data by causing a laser beam to be irradiated through a light transmission layer, comprising:
a substrate having a plurality of convex pits formed on a surface thereof;
the light transmission layer; and
a reflective layer formed between the substrate and the light transmission layer,
wherein the convex pits has a smaller length than a basic length BL to be determined according to data to be recorded, and
the length of spaces between the convex pits adjacent to each other in a track direction has a larger length than the basic length BL.

9. The ROM-type optical recording medium according to claim 8, wherein if a distance from a surface of the reflective layer to the surface of the substrate is assumed as D, the convex pits has a length of BL−(0.1 to 0.3)·D, and the spaces have a length of BL+(0.1 to 0.3)·D.

10. The ROM-type optical recording medium according to claim 8, wherein the reflective layer is formed of Ag or an alloy containing Ag.

11. The ROM-type optical recording medium according to claim 8, wherein the reflective layer is made of a material that contains aluminum (Al) as a main component and has an additive added thereto.

12. The ROM-type optical recording medium according to claim 11, wherein the additive contains at least one element selected from a group consisting of magnesium (Mg), silicon (Si), titan (Ti), ferrum (Fe), copper (Cu), zinc (Zn), germanium (Ge), tantalum (Ta), tungsten (W), palladium (Pd), silver (Ag), platinum (Pt) and gold (Au).

13. The ROM-type optical recording medium according to claim 8, further comprising a hard coat layer formed on a surface of the light transmission layer.

14. The ROM-type optical recording medium according to claim 13, wherein said hard coat layer including an activation energy ray-curable resin.

15. A stamper for manufacturing a ROM-type optical recording medium, wherein a plurality of convex pits are formed on the surface of the stamper, the convex pits have a larger length than a basic length BL to be determined according to data to be recorded on the ROM-type optical recording medium, and the length of spaces between the convex pits adjacent to each other in a track direction has a smaller length than the basic length BL.

16. The stamper for manufacturing a ROM-type optical recording medium according to claim 15, wherein the ROM-type optical recording medium includes a substrate; a light transmission layer; and a reflective layer formed between the substrate and the light transmission layer, and if a distance from a surface of the reflective layer to the surface of the substrate is assumed as D, the convex pits has a length of BL+(0.1 to 0.3)·D, and the length of spaces between the convex pits adjacent to each other in a track direction has a length of BL−(0.1 to 0.3)·D.

17. A stamper for manufacturing a ROM-type optical recording medium, wherein a plurality of concave pits are formed on the surface of the stamper, the concave pits have a smaller length than a basic length BL to be determined according to data to be recorded on the ROM-type optical recording medium, and the length of spaces between the concave pits adjacent to each other in a track direction has a larger length than the basic length BL.

18. The stamper for manufacturing a ROM-type optical recording medium according to claim 17, wherein the ROM-type optical recording medium includes a substrate; a light transmission layer; and a reflective layer formed between the substrate and the light transmission layer, and if a distance from a surface of the reflective layer to the surface of the substrate is assumed as D, the concave pits have a length of BL−(0.1 to 0.3)·D, and the length of spaces between the concave pits adjacent to each other in a track direction has a length of BL+(0.1 to 0.3)·D.
